(19) United States
(12) Patent Application Publication
(10) Pub. No.: US 2020/0283337 A1
(43) Pub. Date: Sep. 10, 2020

(54) TWISTED STEEL MICRO REINFORCED CLADDING SYSTEM

(71) Applicant: Pensmore Reinforced Technologies, LLC, Ann Arbor, MI (US)

(72) Inventors: Steve Huff, Leesburg, VA (US); Luke Pinkerton, Ann Arbor, MI (US)

(21) Appl. No.: 16/650,537

(22) PCT Filed: May 16, 2018
(86) PCT No.: PCT/US2018/032926

§ 371 Date: Mar. 25, 2020

Related U.S. Application Data
(60) Provisional application No. 62/563,740, filed on Sep. 27, 2017.

(51) Int. Cl. C04B 14/48; E04C 5/01; E04F 13/08; E04C 2/38; C04B 20/00

(52) U.S. Cl. CPC C04B 14/48; E04C 5/012; E04F 13/0803; C04B 2111/542; C04B 20/006; C04B 2201/50; E04C 2/382

(57) ABSTRACT

A cladding system for use on the external surface of a building structure that includes a continuous rail system to attach a cladding panel that interlocks with itself. The rail system includes a tongue and groove system to attach the cladding system to the building thereby avoiding the need to use discrete anchors. The cladding panel is formed of a high strength concrete matrix and, optionally, a plurality of twisted steel micro reinforcements (TSMR) dispersed therein.

### FIELD

This disclosure relates generally to cementitious building cladding.

### BACKGROUND

The statements in this section merely provide background information related to the present disclosure and may not constitute prior art.

Cladding systems can be applied to a building or structure in order to protect the exterior and the frame of the building or structure. Indirectly, these cladding systems may also protect the interior of the building or structure. In addition, such cladding systems may also increase the aesthetic appeal of a building or structure.

Conventional cladding systems made with concrete use discrete anchors to secure the cladding to buildings.

### SUMMARY

The present disclosure generally provides cementitious building cladding that is affixed to buildings, either new construction or retrofitted onto existing buildings. The subject-matter of the disclosure may relate, among others, to the following aspects:

Aspect 1: A cladding system for use on the external surface of a building structure, the cladding system comprising a continuous rail system to attach a cladding panel that interlocks with itself; wherein the rail system comprises a tongue and groove system to attach the cladding system to the building thereby avoiding the need to use discrete anchors.

Aspect 2: The cladding system according to Aspect 1, wherein the cladding panel comprises a high strength concrete matrix and, optionally, a plurality of twisted steel micro reinforcements (TSMR) dispersed therein.

Aspect 3: The cladding system according to any of Aspects 1 or 2, wherein the cladding panel exhibits a compressive strength between about 4,000 psi and about 40,000 psi.

Aspect 4: The cladding system according to Aspect 3, wherein the cladding panel exhibits a compressive strength of about 12,000 psi.

Aspect 5: The cladding system according to Aspect 2, wherein the TSMR is made of stainless steel or zinc plated nonstainless steel.

Aspect 6: The cladding system according to any of Aspects 2 or 5, wherein the TSMR is incorporated into the concrete matrix in a dosage that is between about 15 and about 250 lbs/yd.

Aspect 7: The cladding system according to any of Aspects 1-6, wherein the cladding system further comprises a continuous wedge that engages the cladding panel and secures it to a horizontal cleat.

Aspect 8: The cladding system according to Aspect 7, wherein the wedge acts as a water stop.

Aspect 9: The cladding system according to any of Aspects 1-8, wherein the surface of the cladding system is designed to have the appearance of natural stone.

Aspect 10: The cladding system according to any of Aspects 1-9, wherein the cladding panel is designed to exhibit blast and impact resistant properties.

Aspect 11: The cladding system according to any of Aspects 1-10, wherein the cladding system is formed with integral corbels.

Aspect 12: The cladding system according to any of Aspects 1-11, wherein the cladding system is formed with integral gutters.

Aspect 13: The cladding system according to any of Aspects 1-12, wherein the cladding panel is formed with a portion of an external surface being shaped in the form of a corbel, a gutter, an animal head, a gargoyle, an iconic capital, or another architectural feature.

Aspect 14: The cladding system according to Aspect 2, wherein the cladding panel includes the TSMR and is formed with a portion of an external surface being shaped in the form of a corbel, a gutter, an animal head, a gargoyle, an iconic capital, or another architectural feature.

Aspect 15: The cladding system according to any of Aspects 1-14, wherein the cladding panel has a thickness that is between about ½ inch and about 6 inches.

Aspect 16: The cladding system according to any of Aspects 1-15, wherein the cladding panel is rectangular or non-rectangular having external dimensions within the range of about 4″×4″ to about 6′×6′.

Aspect 17: A method of manufacturing a cladding system of any of Aspects 1-16, wherein the manufacturing method comprises a continuous assembly line.

Aspect 18: A building structure comprising an external surface, wherein at least a portion of the external surface comprises the cladding system according to any of Aspects 1-17.

Aspect 19: A building structure comprising an external surface, wherein at least a portion of the external surface comprises the cladding system manufactured according to Aspect 17.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a cladding system formed according to the teachings of the present disclosure installed on a building;

FIG. 1B is a perspective view of another cladding system formed according to the teachings of the present disclosure installed on a building that highlights horizontal cleats;

FIG. 2A is a plot of compressive strength for conventional plain concrete and the TSMR concrete of the present disclosure;

FIG. 2B is a plot of Modulus of rupture and the splitting tensile stress for conventional plain concrete and the TSMR concrete of the present disclosure;

FIG. 3 is a cross-sectional view showing details of the cladding connection mechanism;

FIG. 4 is a cross-sectional view of a gutter corbel formed according to the details of the present disclosure;

FIG. 5 is a schematic representation of the filler panel located between gutters according to one aspect of the present disclosure;

FIG. 6 is a schematic representation of a corbel according to another aspect of the present disclosure;

FIG. 7 is a cross-sectional view of the connection of a corbel to a building according to the teachings of the present disclosure;

FIG. 8A is perspective view of cladding formed according to the teachings of the present disclosure with an animal face formed thereon; and

FIG. 8B is a perspective view of a capital cladding formed according the teachings of the present disclosure.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the cladding made and used according to the teachings contained herein is described throughout the present disclosure in conjunction with the appearance of natural stone in order to more fully illustrate the composition and the use thereof. The incorporation and use of such cladding in applications that require the cladding to comprise a different texture, or the like are contemplated to be within the scope of the present disclosure. It should be understood that throughout the description, corresponding reference numerals indicate like or corresponding parts and features.

The present disclosure generally provides cementitious building cladding that is affixed to buildings, either new construction or retrofitted onto existing buildings. The cladding has the appearance of natural stone (or any other texture desired), is made of high strength concrete reinforced with twisted steel micro reinforcement (TSMR) and is affixed to the building using a unique continuous connection system.

The cladding comprises, consists of, or consists essentially of thin pieces of precast high strength concrete reinforced with twisted steel micro reinforcement (TSMR). The panels are attached to the building using a tongue and groove system as demonstrated herein that both attach the panels to the building and to each other without the need for the use of discrete anchor points. Avoiding the need for such discrete anchors eliminates concerns of structural adequacy of the anchors. The adoption of concrete cladding panels has been hampered given the adequacy of such discrete anchors is not covered in current building codes. The cladding system of the present disclosure reduces or when desirable eliminates the need for such anchors. The cladding also has blast and impact resistant properties.

Rectangular concrete mesh panels and/or decorative items made with ˜12,000 psi compressive strength concrete are formed using a precast method. Alternatively, the compressive strength is between about 4,000 psi and 40,000 psi; alternatively, about 8,000 psi to about 20,000 psi; alternatively, from about 10,000 psi to about 16,000 psi. The panels employ a tongue and grove along with a wedge and locking rail system to secure the cladding to the building in a continuous manner, thereby reducing and when desirable eliminating the need for discrete concrete anchors. The new attachment system avoids stress concentration points by uniformly spreading the attachment load on a continuous or nearly continuous wedge.

Twisted steel micro reinforcement (TSMR) improves the ultimate flexural and tensile reinforcement of the concrete panels by providing an enhanced bond with the concrete matrix. TSMR increases cracking resistance of concrete because the twisted shape allows for load transfer from the concrete into the TSMR prior to the development of visible cracks. TSMR also increases the shear strength, impact resistance and durability of the concrete.

For the purpose of this disclosure the terms “about” and “substantially” are used herein with respect to measurable values and ranges due to expected variations known to those skilled in the art (e.g., limitations and variability in measurements).

Furthermore, any range in parameters that is stated herein as being “between [a 1^{st} number] and [a 2^{nd} number]” or “between [a 1^{st} number] to [a 2^{nd} number]” is intended to be inclusive of the recited numbers. In other words, the ranges are meant to be interpreted similarly as to a range that is specified as being “from [a 1^{st} number] to [a 2^{nd} number]”.

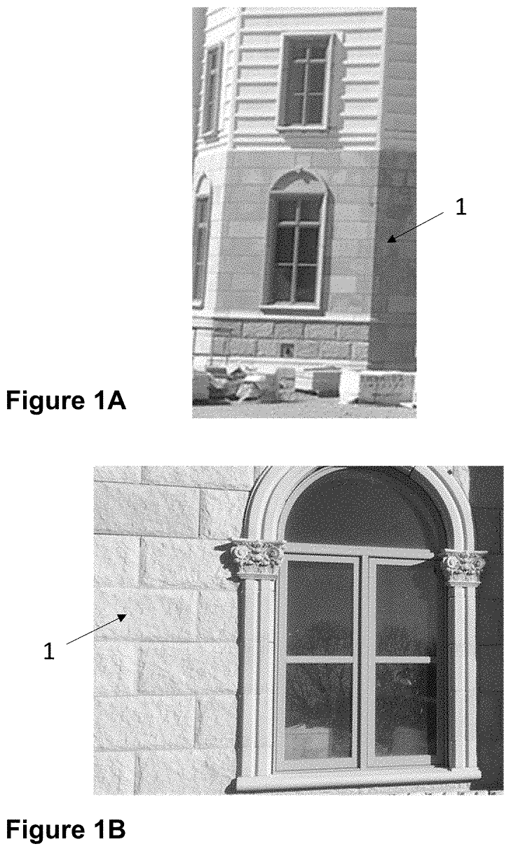

Referring to FIGS. 1A and 1B, the cladding system 1 is made of high strength concrete ˜12000 psi (˜82 MPa). The concrete could have compressive strengths between 4,000 psi (e.g., 27.5 MPa) and 40,000 psi (e.g., 275 MPa). The concrete is reinforced with twisted steel micro reinforcements as further described in U.S. Pat. Nos. 5,989,713 and 9,440,991, the entire contents of which are hereby incorporated by reference in their entirety. The dosage of twisted steel micro reinforcement (TSMR) is between about 15 lbs/yd (e.g., about 8.9 kg/m³) and about 250 lbs/yd (e.g., about 148 kg/m³). The twisted steel micro reinforcement (TSMR) may be made of, without limitation, stainless steel or zinc plated steel (e.g., nonstainless).

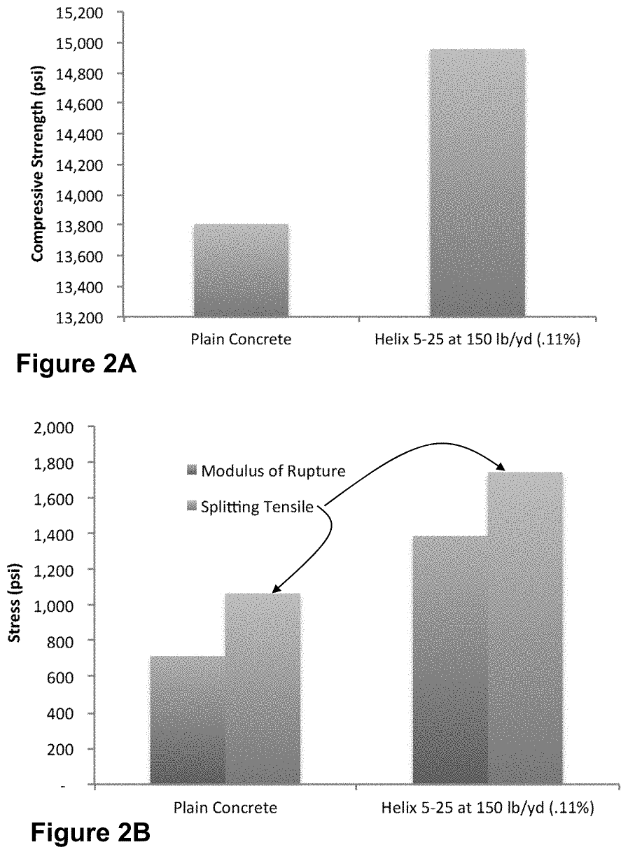

The TSMR increases the compressive, flexural and splitting tensile strength of the concrete by as much as 100% or more as shown in FIGS. 2A and 2B. Alternatively, the cladding of the present disclosure may be formed without the inclusion of the TSMR for use in applications that do not require the enhanced properties provided by the TSMR.

Still referring to FIGS. 1A and 1B, the cladding is approximately 1 inch (˜2.54 cm) thick. When desired, the cladding may exhibit a variety of thicknesses ranging between about ½ inch and about 6 inches. The panels could be non-rectangular and could range in size, without limitation, about 4″×4″ (inches) to about 6′×6′ (feet).

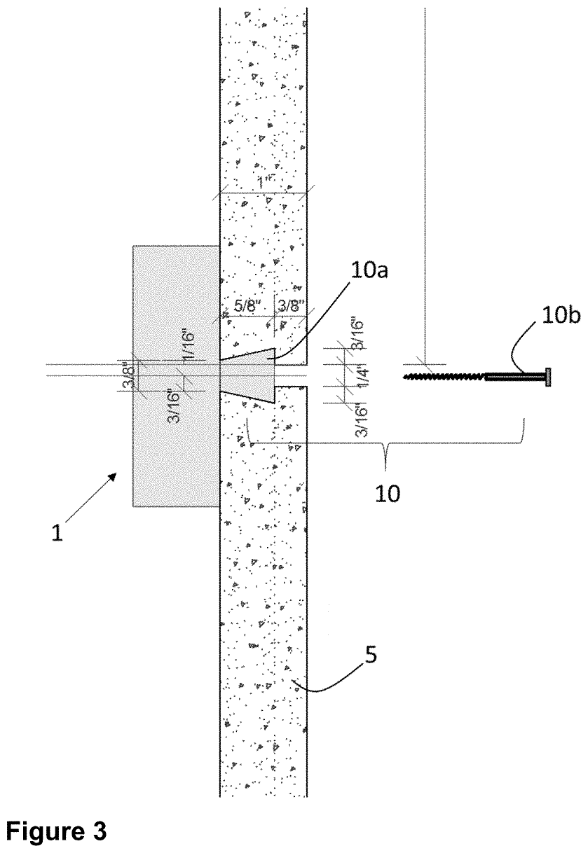

Referring now to FIG. 3, the panels 1 may be attached to the face of the building 5 using a wedge and screw system 10 comprising wedges 10a and screws 10b that lock the cladding in a continuous manner to a horizontal cleat (shown in FIGS. 1A & 1B) secured to the building. The wedge 10a as shown in FIG. 3 also acts as a water stop. The wedges 10a are spaced at a regular interval.

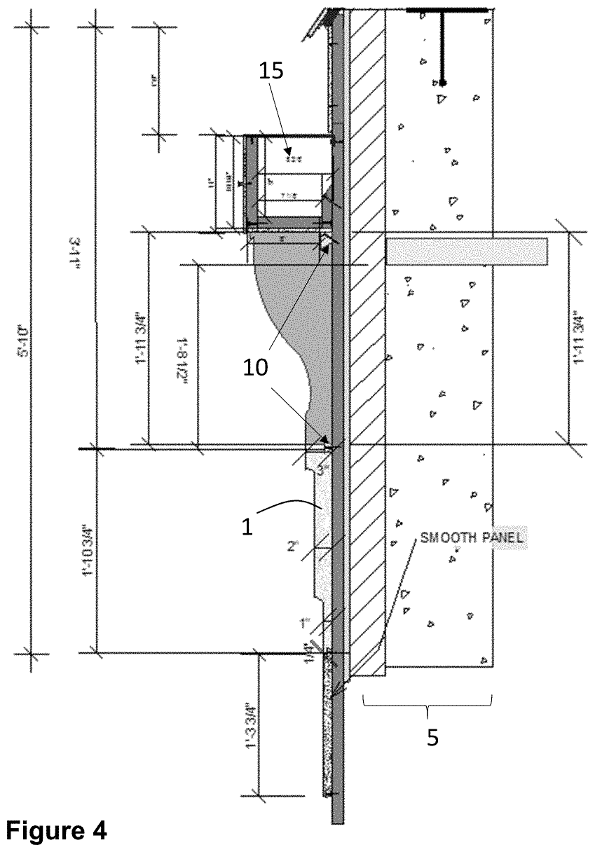

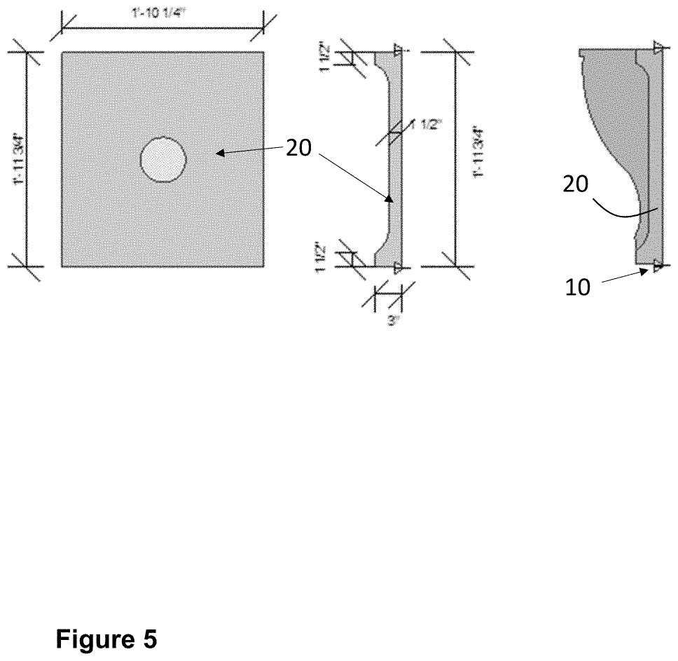

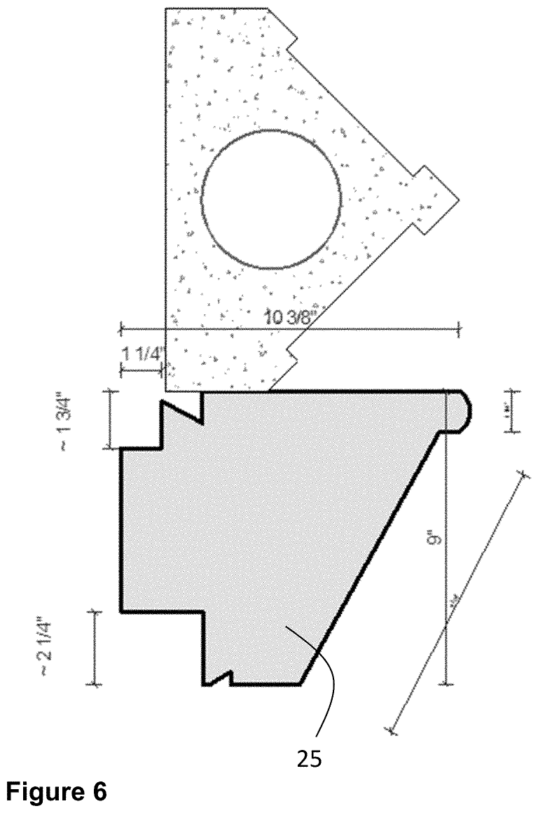

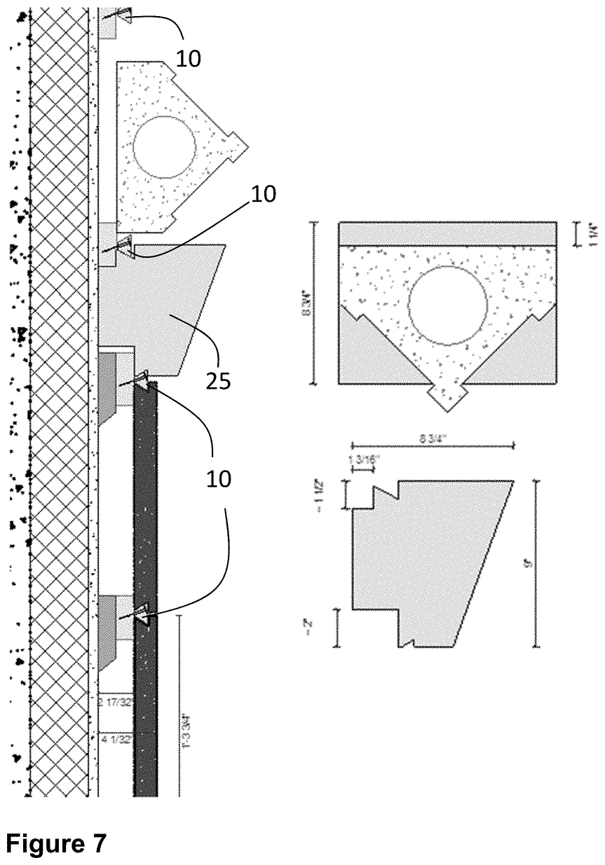

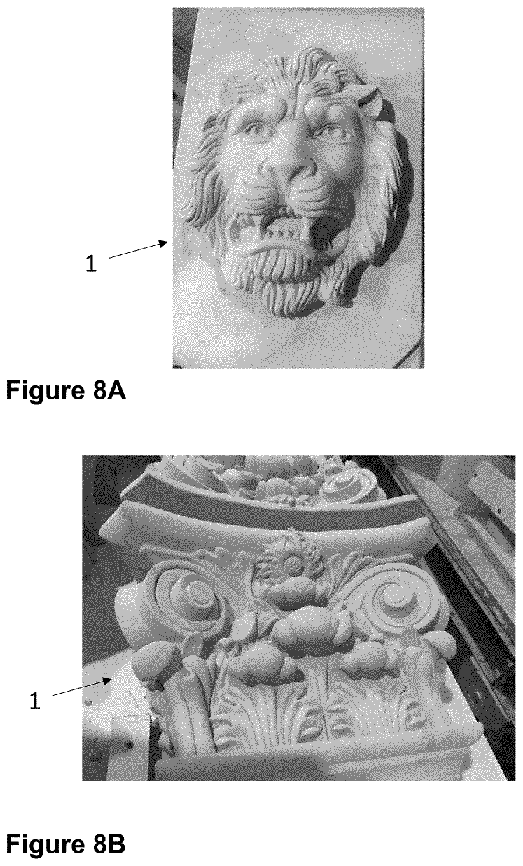

The system may also incorporate integral gutters 15 that use the same wedge system 10 to secure to the building 5 and adjacent cladding 1 as shown in FIG. 4. A special filler panel 20 secured using the typical wedge system 10 is available and may be used as shown in FIG. 5. Similarly, the system also incorporates integral corbels 25 (see FIG. 6) that are secured using a standard wedge system 10 (see FIG. 7). The same concrete system 1 can be used to make unique shapes corbels, gutters, animal heads, gargoyles, iconic capitals, and other architectural features, with examples thereof being shown in FIGS. 8A and 8B. When desirable, the system may be manufactured in a continuous (e.g., assembly line) manner that may be manual or automated.

The following specific example is given to illustrate the cladding system of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

### Example 1

According to one aspect of the present disclosure, a cladding panel is formed that is about 1″+/−0.1 in thick, made with 12,000 psi concrete reinforced with 150 lbs/yd of stainless steel TSMR (Helix 5-25, Helix Steel, Michigan). The panel is rectangular and has a texture of the outer surface designed to look and feel like natural stone.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A cladding system for use on the external surface of a building structure, the cladding system comprising a continuous rail system to attach a cladding panel that interlocks with itself;
wherein the rail system comprises a tongue and groove system to attach the cladding system to the building thereby avoiding the need to use discrete anchors.

2. The cladding system according to claim 1, wherein the cladding panel comprises a high strength concrete matrix and, optionally, a plurality of twisted steel micro reinforcements (TSMR) dispersed therein.

3. The cladding system according to claim 1, wherein the cladding panel exhibits a compressive strength between about 4,000 psi and about 40,000 psi.

4. The cladding system according to claim 3, wherein the cladding panel exhibits a compressive strength of about 12,000 psi.

5. The cladding system according to claim 2, wherein the TSMR is made of stainless steel or zinc plated nonstainless steel.

6. The cladding system according to claim 2, wherein the TSMR is incorporated into the concrete matrix in a dosage that is between about 15 lbs/yd and about 250 lbs/yd.

7. The cladding system according to claim 1, wherein the cladding system further comprises a continuous wedge that engages the cladding panel and secures it to a horizontal cleat.

8. The cladding system according to claim 7, wherein the wedge acts as a water stop.

9. The cladding system according to claim 1, wherein the surface of the cladding system is designed to have the appearance of natural stone.

10. The cladding system according to claim 1, wherein the cladding panel is designed to exhibit blast and impact resistant properties.

11. The cladding system according to claim 1, wherein the cladding system is formed with integral corbels.

12. The cladding system according to claim 1, wherein the cladding system is formed with integral gutters.

13. The cladding system according to claim 1, wherein the cladding panel is formed with a portion of an external surface being shaped in the form of a corbel, a gutter, an animal head, a gargoyle, an iconic capital, or another architectural feature.

14. The cladding system according to claim 2, wherein the cladding panel includes the TSMR and is formed with a portion of an external surface being shaped in the form of a corbel, a gutter, an animal head, a gargoyle, an iconic capital, or another architectural feature.

15. The cladding system according to claim 1, wherein the cladding panel has a thickness that is between about ½ inch and about 6 inches.

16. The cladding system according to claim 1, wherein the cladding panel is rectangular or non-rectangular having external dimensions within the range of about 4″×4″ to about 6′×6′.

17. A method of manufacturing a cladding system of claim 1, wherein the manufacturing method comprises a continuous assembly line.

18. A building structure comprising an external surface, wherein at least a portion of the external surface comprises the cladding system according to claim 1.

19. A building structure comprising an external surface, wherein at least a portion of the external surface comprises the cladding system manufactured according to claim 17.
